(19) United States
(12) Patent Application Publication
(10) Pub. No.: US 2007/0001031 A1
(43) Pub. Date: Jan. 4, 2007

(54) Multilayer piezoelectric element and fuel injector

(75) Inventor: Satoshi Sasaki, Akita (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/126,227

(22) Filed: May 11, 2005

(30) Foreign Application Priority Data
May 25, 2004 (JP) P2004-155123

(51) Int. Cl. B05B 1/08; F02M 63/00

(52) U.S. Cl. 239/533.2; 239/102.2

(57) ABSTRACT

A multilayer piezoelectric element comprises a piezoelectric layer, a first electrode layer, and a second electrode layer having a region opposing the first electrode layer by way of a piezoelectric layer. A region where the first and second electrode layers overlap forms a piezoelectrically active region adapted to displace the piezoelectric layer when a voltage is applied between the first and second electrode layers. At least one of a plurality of inner electrode layers is provided with a perforated portion penetrating therethrough in a laminating direction. The perforated portion is formed in at least a region corresponding to the piezoelectrically active region in the inner electrode layer.

### BACKGROUND OF THE INVENTION

1. Field of the Invention

The present invention relates to a multilayer piezoelectric element which is displaced when a voltage is applied thereto, and a fuel injector equipped with the multilayer piezoelectric element.

2. Related Background Art

Known as an example of conventional multilayer piezoelectric elements is one disclosed in Japanese Patent Application Laid-Open No. HEI 7-106654. The multilayer piezoelectric element disclosed in Japanese Patent Application Laid-Open No. HEI 7-106654 comprises a multilayer body formed by alternately laminating thin plates made of a piezoelectric ceramic material and inner electrodes made of a conductive material. Side faces of the multilayer body are provided with outer electrodes to connect with the inner electrodes. When a voltage is applied to the outer electrodes, an electric field is generated between positive and negative electrodes, whereby the thin plates mechanically expand or contract, thus yielding a displacement.

### SUMMARY OF THE INVENTION

However, the multilayer piezoelectric element in which piezoelectric layers made of a piezoelectric ceramic material are thinned as in the prior art mentioned above has been problematic in that the piezoelectric layers may fail to attain a sufficient amount of displacement. Such a problem has recently become remarkable in particular, since multilayer piezoelectric elements have been made smaller and thinner.

It is an object of the present invention to provide a multilayer piezoelectric element and a fuel injector which can increase the amount of displacement of piezoelectric layers.

The inventors conducted diligent studies and, as a result, have found that the inner electrodes required for applying a voltage become one of factors inhibiting the piezoelectric layers from being deformed (displaced). Namely, the inner electrode layers made of a conductive metal material appear to be metal plates attached to the piezoelectric layers. The inner electrode layers themselves are not directly deformed by a voltage applied thereto. Therefore, in the case where the inner electrode layers are completely flat as in the above-mentioned prior art, they become a great burden against the deformation of the piezoelectric layers when a voltage is applied to the inner electrode layers. As a result, the amount of displacement is suppressed in the piezoelectric layers. The present invention is based on these findings.

In one aspect, the present invention provides a multilayer piezoelectric element constructed by alternately laminating a piezoelectric layer and an inner electrode layer; wherein the piezoelectric element includes a plurality of inner electrode layers; wherein the plurality of inner electrode layers include a first electrode layer and a second electrode layer having a region opposing the first electrode layer by way of the piezoelectric layer; wherein a region where the first and second electrode layers overlap forms a piezoelectrically active region adapted to displace the piezoelectric layer when a voltage is applied between the first and second electrode layers; wherein at least one of the plurality of inner electrode layers is formed with a perforated portion penetrating therethrough in a laminating direction; and wherein the perforated portion is formed in at least a region corresponding to the piezoelectrically active region in the inner electrode layer.

In the multilayer piezoelectric element of the present invention, the piezoelectrically active region where the first and second electrode layers in the inner electrode layers overlap is a region involved in the deformation (displacement) of the piezoelectric layers. Forming the perforated portion in at least a region corresponding to the piezoelectrically active region in the inner electrode layer reduces the contact area between the surface of the inner electrode layer and the piezoelectric layer in the piezoelectrically active region. This reduces the load exerted on the piezoelectric layers from the inner electrode layers when a voltage is applied between the first and second electrode layers. As a result, the piezoelectric layers are more likely to deform and can increase their amount of displacement.

Since the piezoelectric layer and the inner electrode layer are formed from respective materials which are totally different from each other, the bonding strength therebetween may become problematic. Forming an inner electrode layer with a perforated portion allows two piezoelectric layers positioned so as to hold the inner electrode layer therebetween to connect with each other through the perforated portion. As a consequence, delamination is harder to occur between the piezoelectric layer and inner electrode layer, whereby the bonding strength therebetween becomes higher. This improves the durability of the multilayer piezoelectric element.

Preferably, the perforated portion is formed as a porous portion in at least the region corresponding to the piezoelectrically active region in the inner electrode layer. This can further reduce the contact area between the surface of the inner electrode layer and the piezoelectric layer in the piezoelectrically active region, so that the piezoelectric layer can be made easier to deform, whereby the amount of displacement can further be increased. Since a plurality of holes are formed throughout the region corresponding to the piezoelectrically active region in the inner electrode layer, the piezoelectric layers are easier to deform throughout the piezoelectrically active region. This can improve the in-plane uniformity in the amount of displacement of the piezoelectric layers. Further, two piezoelectric layers positioned so as to hold the inner electrode layer therebetween connect with each other through a plurality of holes, whereby the piezoelectric layers adhere to the inner electrode layer more fully.

Preferably, the inner electrode layers are formed from a material mainly composed of copper. Copper is a metal rich in malleability and ductility. An inner electrode layer material mainly composed of copper can effectively contribute to deforming the piezoelectric layers. Since copper is relatively less expensive, the cost required for making a multilayer piezoelectric element can be cut down.

In another aspect, the present invention provides a fuel injector comprising a body formed with an injection port for injecting a fuel; a valve, disposed within the body, for opening and closing the injection port; and a multilayer piezoelectric element for driving the valve; wherein the multilayer piezoelectric element is constructed by alternately laminating a piezoelectric layer and an inner electrode layer; wherein the piezoelectric element includes a plurality of inner electrode layers, the plurality of inner electrode layers including a first electrode layer and a second electrode layer having a region opposing the first electrode layer by way of the piezoelectric layer; wherein a region where the first and second electrode layers overlap forms a piezoelectrically active region adapted to displace the piezoelectric layer when a voltage is applied between the first and second electrode layers; wherein at least one of the plurality of inner electrode layers is formed with a perforated portion penetrating therethrough in a laminating direction; and wherein the perforated portion is formed in at least a region corresponding to the piezoelectrically active region in the inner electrode layer.

When the above-mentioned multilayer piezoelectric element is thus provided, the piezoelectric layers are easier to deform as mentioned above, whereby the piezoelectric layers can increase their amount of displacement. This makes it possible to regulate the amount of injection of fuel over a wide range. Since the bonding strength between the piezoelectric layer and inner electrode layer becomes higher as mentioned above, the multilayer piezoelectric element improves its durability. This leads to an improvement in the durability of the fuel injector.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a vertical sectional view showing the multilayer piezoelectric element in accordance with an embodiment;

FIG. 2 is a horizontal sectional view of the multilayer body shown in FIG. 1;

FIG. 3 is a view showing a measurement system for evaluating the displacement of the multilayer piezoelectric element;

FIG. 4 is a graph showing results of evaluating the displacement of the multilayer piezoelectric element with the measurement system shown in FIG. 3;

FIG. 5 is a view showing a measurement system for evaluating the interlayer strength of the multilayer piezoelectric element; and

FIG. 6 is a schematic view showing a fuel injector equipped with the multilayer piezoelectric element shown in FIG. 1.

### DESCRIPTION OF THE PREFERRED EMBODIMENTS

In the following, preferred embodiments of the present invention will be explained in detail with reference to the accompanying drawings. In the explanation, constituents identical to each other or those having functions identical to each other will be referred to with numerals identical to each other without repeating their overlapping descriptions.

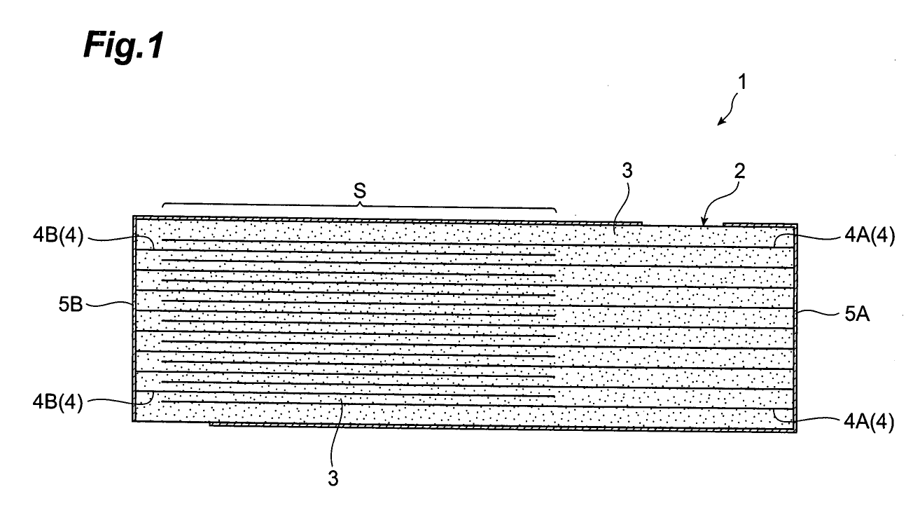

FIG. 1 is a sectional view showing the multilayer piezoelectric element in accordance with an embodiment. In this drawing, the multilayer piezoelectric element 1 is equipped with a rectangular parallelepiped multilayer body 2. The multilayer body 2 is constructed by alternately laminating piezoelectric layers 3 and inner electrode layers 4. Here, 18 piezoelectric layers 2 and 17 inner electrode layers 4 are formed. The numbers of piezoelectric layers 3 and inner electrode layers 4 are not restricted in particular. The piezoelectric layers 3 are formed from a piezoelectric ceramic material mainly composed of PZT (lead zirconate titanate), for example.

The 17 inner electrode layers 4 are constituted by 9 electrode layers 4A and 8 electrode layers 4b. The electrode layers 4A, 4B are alternately laminated such that their partial regions oppose each other while alternating with the piezoelectric layers 3. One kind of the electrode layers 4A, 4B constitutes a positive electrode layer, whereas the other constitutes a negative electrode layer. The electrode layers 4A, 4B are formed from a metal material in which the ratio of Ag:Pd=7:3, for example.

One side face of the multilayer body 2 is provided with an outer electrode 5A electrically connected to the electrode layers 4A. The outer electrode 5A extends to the upper and lower faces of the multilayer body 2. Another side face of the multilayer body 2 is provided with an outer electrode 5B electrically connected to the electrode layers 4B. The outer electrode 5B extends to the upper face of the multilayer body 2. Respective leads (not depicted) for voltage application are connected to the outer electrodes 5A, 5B. The outer electrodes 5A, 5B are formed from Au, for example.

In this multilayer piezoelectric element 1, a region S where the electrode layers 4A and 4B overlap forms a piezoelectrically active region adapted to displace the piezoelectric layer 3 when a voltage is applied between the outer electrodes 5A and 5B, i.e., between the electrode layers 4A and 4B. The multilayer piezoelectric element body 1 has a size of 5.5 mm (length)×0.75 mm (width)×0.55 mm (thickness), for example. The length of the piezoelectrically active region S is 3 mm, for example, whereas the width of the piezoelectrically active region S is the same as the width (0.75 mm) of the multilayer piezoelectric element body 1, for example. The thickness per layer of the piezoelectric layers 3 in the piezoelectrically active region S is about 25 μm except for the uppermost and lowermost layers, and is about 50 μm in the uppermost and lowermost layers. The electrode layers 4A, 4B have a thickness of about 2 μm each.

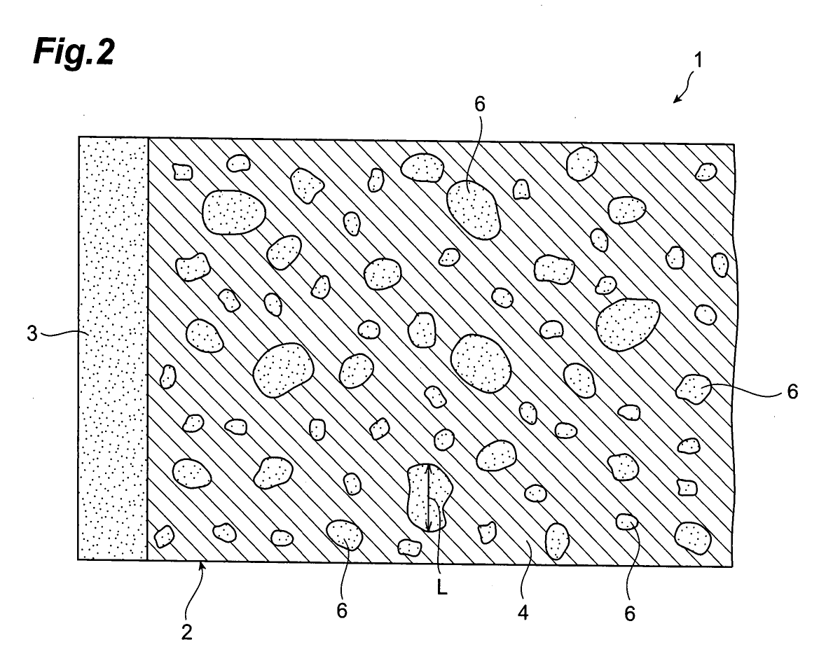

As shown in FIG. 2, each of the inner electrode layers 4 (electrode layers 4A, 4B) is formed with a plurality of holes 6 penetrating through the inner electrode layers 4 in the laminating direction thereof. These holes 6 may be formed like a porous portion only in a region corresponding to the piezoelectrically active region S in the inner electrode layer 4. The holes 6 may be formed like a porous portion throughout the inner electrode layer 4. The holes 6 may have any form such as circle, rectangle, mesh, or stripe as long as they are formed like a porous portion in the inner electrode layer 4. The form, size, and the like of the holes 6 may be random as shown in FIG. 2 or uniform.

When each inner electrode layer 4 is thus provided with a plurality of holes 6, the area covering the piezoelectric layer 3 (the area in contact with the piezoelectric layer 3) becomes relatively small in the region corresponding to the piezoelectrically active region S in the surface of the inner electrode layer 4. This weakens the force by which the inner electrode layers 4 repress the piezoelectric layers 3. Therefore, when a voltage is applied between the inner electrode layers 4 (electrode layers 4A, 4B), the inner electrode layers 4 easily deform (expand/contract) so as to follow the piezoelectric layers 3. As a result, the weight load exerted on the piezoelectric layers 3 from the inner electrode layers 4 is reduced, whereby the inner electrode layers 4 are prevented from reducing the amount of displacement of the piezoelectric layers 3.

Since a plurality of holes 6 are formed throughout the region corresponding to the piezoelectrically active region S in the inner electrode layers 4, the weight load exerted on the piezoelectric layers 3 from the inner electrode layers 4 is lowered in the whole piezoelectrically active region S. This reduces the in-plane fluctuation in the amount of displacement in the piezoelectric layers 3.

The piezoelectric layers 3 on the upper and lower sides of each inner electrode layer 4 are connected to each other with a plurality of holes 6. Namely, each hole 6 exhibits an anchor effect for connecting the piezoelectric layers 3 to each other. As a consequence, delamination is harder to occur between the piezoelectric layers 3 and inner electrode layers 4, whereby the adhesion therebetween improves.

The ratio by which the surface of each inner electrode layer 4 covers its corresponding piezoelectric layer 3 in the piezoelectrically active region S (hereinafter referred to as inner electrode coverage ratio) is preferably 60 to 90%, more preferably 65 to 85%. The inner electrode coverage ratio specifically refers to the ratio (S/S₀) concerning the piezoelectrically active region S in the surface of the inner electrode layer 4 between its area S₀ obtained on the assumption that there are no holes 6 at all and the area S obtained when subtracting the total area of the holes 6 from the former area S₀. Such an inner electrode coverage ratio as that mentioned above can sufficiently restrain the inner electrode layer 4 from inhibiting the piezoelectric layer 3 covered therewith from being displaced. This can also reliably prevent the effective area of the inner electrode layer 4 required for displacing the piezoelectric layer 3 from becoming too small and deteriorating the displacement of the piezoelectric layer 3 by contraries.

As a size of the holes 6, the average value of maximum aperture length L (see FIG. 2) is preferably 10 μm or less, 1 to 7 μm or less in particular. This can prevent the inner electrode layers 4 from losing their continuity and causing conduction failures after processing the multilayer piezoelectric element into a comb form (having a width of 50 to 100 μm, for example).

A procedure of making the above-mentioned multilayer piezoelectric element 1 will now be explained. First, green sheets for forming the piezoelectric layers 3 are formed.

Specifically, a piezoelectric ceramic powder mainly composed of PZT (lead zirconate titanate) having the following composition, for example, is prepared as a ceramic material constituting the piezoelectric layers 3. Employed as the piezoelectric ceramic powder is one obtained by weighing and mixing start materials such as oxides, carbonates, and the like so as to attain the following composition, thereafter temporarily firing the mixture at about 900° C. for about 2 hours, and pulverizing the fired mixture into fine powder. An organic binder, an organic solvent, and the like are mixed into the powder, so as to make a paste, which is then formed into a sheet with a PET film used as a carrier film.

(Pb0.96 Sr0.04) [Zr0.53 Ti0.47]O₃+0.5 wt % of Nb₂O₅ per 1 mol of the main ingredient

Subsequently, an inner electrode pattern to form an inner electrode layer 4 is printed on each of thus formed green sheets. Specifically, using a paste produced by mixing a metal material in which the ratio of Ag:Pd=7:3 with an organic binder, an organic solvent, and the like, for example, the inner electrode pattern is formed on the green sheet by screen printing. Here, the inner electrode pattern is designed such that a plurality of multilayer piezoelectric elements can be cut out after firing which will be explained later. The inner electrode pattern is also designed such that the inner electrode layer 4 having a plurality of holes 6 are formed by firing.

The number, shape, size, and the like of holes 6 formed in the inner electrode layer 4 can be regulated by the following techniques. In one technique, a screen printing plate for printing an inner electrode pattern for use is provided beforehand with holes with a desirable number, form, size, and the like. As other techniques, the particle size may be varied in the metal powder forming the inner electrode paste, the metal content in the inner electrode paste may be changed, or the particle size or amount of a ceramic material powder (having the same composition as that mentioned above) mixed into the inner electrode paste beforehand may be changed. The shrinkage ratio of the metal material forming the inner electrode pattern is greater than that of ceramics forming the piezoelectric layers. As a consequence, a shrinking behavior of the inner electrode pattern may form a plurality of holes in the inner electrode pattern at the time of firing. The shrinking behavior of the inner electrode pattern changes at the time of firing if the amount of material forming the inner electrode pattern and the like are adjusted as mentioned above, whereby the state of holes 6 in the inner electrode layers 4 after the firing can be changed.

Subsequently, a predetermined number of green sheets, each printed with the inner electrode pattern, are laminated. Green sheets with no inner electrode patterns printed thereon are stacked on the upper and lower faces of thus laminated green sheet body, respectively. Such green sheets with no inner electrode patterns are mounted in order to polish the element after firing, which will be explained later, so as to adjust it to a predetermined thickness.

Next, the laminated green sheet body is pressed at a pressure of about 100 MPa while being heated at about 60° C., so as to bond the layers of the green sheet body together under pressure. This completes a multilayer body 2 in which the piezoelectric layers 3 and inner electrode layers 4 are alternately laminated.

Thus obtained multilayer body 2 is mounted on a setter, and is degreased (debindered) for about 10 hours in an air atmosphere at about 400° C. Thereafter, the setter mounted with the multilayer body 2 is put into a closed furnace, and the multilayer body 2 is fired for about 2 hours in the air at about 1100° C., so as to yield a sintered body.

Subsequently, the fired multilayer body 2 is polished, so as to attain a predetermined thickness. Then, the multilayer body 2 is cut such as to yield predetermined length and width. Thereafter, the multilayer body 2 is packed into a mask and subjected to sputtering, whereby the surface of the multilayer body 2 is formed with outer electrodes 5A, 5B made of Au.

Next, in an environment at a temperature of about 100° C., a voltage of 75 V_{dc} is applied to the inner electrode layer 4 for about 3 minutes, so as to polarize the piezoelectric layers 3. The foregoing yields the multilayer piezoelectric element 1 shown in FIG. 1.

Various evaluations actually carried out for the above-mentioned multilayer piezoelectric element 1 will now be explained.

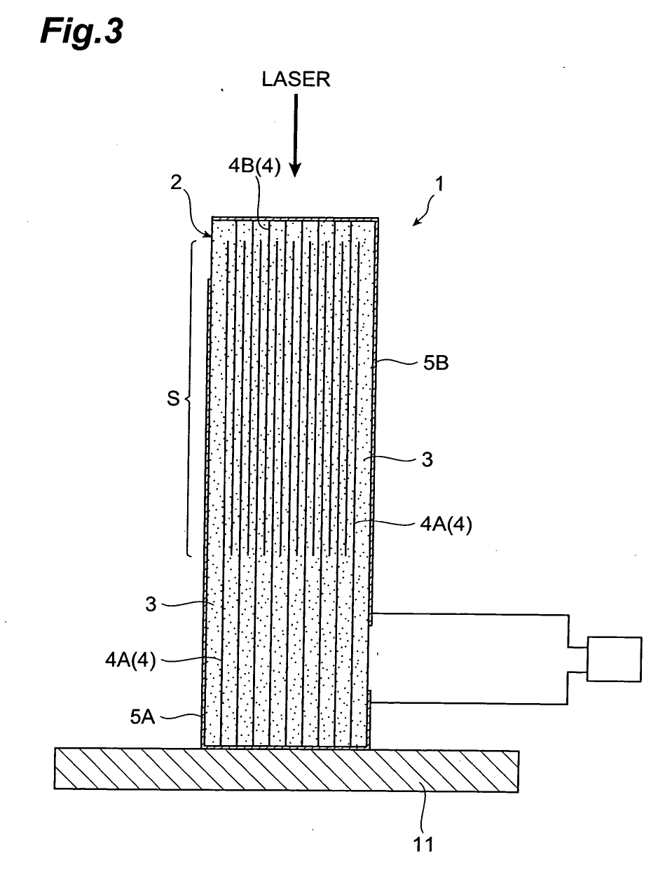

First, using a laser doppler vibrometer, the displacement of the multilayer piezoelectric element 1 in the direction of piezoelectric strain coefficient d₃₁ was evaluated (see FIG. 3). Specifically, while the side face of the multilayer piezoelectric element 1 on the side opposite from the piezoelectrically active region S was secured to a fixed table 11, a sine curve wave of 25 V_{P-P} at 2 kHz was applied between the outer electrodes 5A, 5B. A function generator was used for applying the sine wave. Then, the multilayer piezoelectric element 1 was irradiated with laser from the side opposite from the fixed table 11, and the velocity of vibration of the multilayer piezoelectric element 1 at that time was measured by the laser doppler vibrometer (not depicted). Thus measured velocity of vibration was integrated and converted into a displacement.

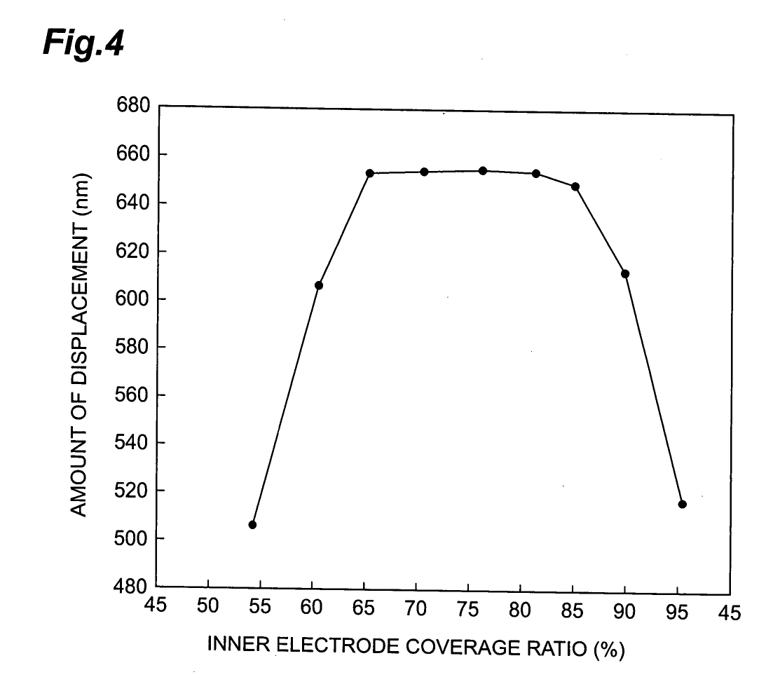

For 10 each of samples with various inner electrode coverage ratios, amounts of displacement were measured and averaged. Thus obtained results are graphed in FIG. 4. Each value of amount of displacement in the graph is an average value of 10 amounts of displacement.

As can be seen from the results of FIG. 4, the amount of displacement of samples was favorable when the inner electrode coverage ratio was 60 to 90%, and the highest value was obtained when the inner electrode coverage ratio was 65 to 85% in particular. Though not shown in the graph of FIG. 4, a greater amount of displacement was obtained even when the inner electrode coverage ratio exceeded 90% (e.g., at 95%) than when the inner electrode coverage ratio was 100% (where the inner electrode layers 4 were totally free of the holes 6).

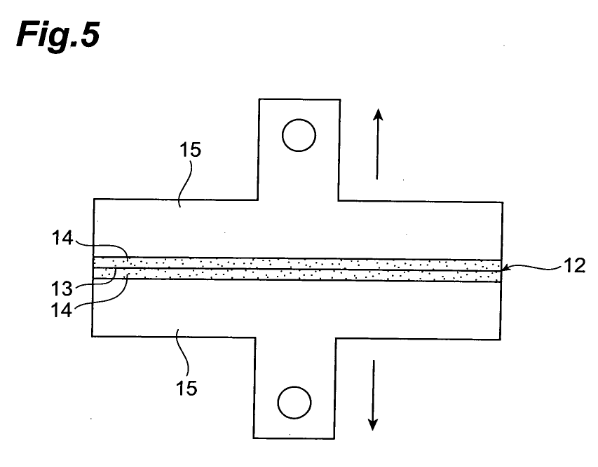

Using a precision load measuring apparatus, the interlayer strength between the piezoelectric layers 3 and inner electrode layers 4 was evaluated (see FIG. 5). Specifically, two samples 12 with respective inner electrode coverage ratios of 80% and 95% were made by substantially the same procedure as that of the multilayer piezoelectric element 1 mentioned above. Each sample 12 had a size of 2 mm×2 mm×0.4 mm. Each sample 12 had a structure provided with one inner electrode layer 13 and no outer electrode. Each sample 12 was held between a pair of metal plates (jigs made of stainless steel) 15 at the upper and lower faces and was bonded with an adhesive to the metal plates 15. In this state, the metal plates 15 were pulled. The load at which the inner electrode layer 13 and a piezoelectric layer 14 were peeled off from each other at their interface was measured by the precision load measuring apparatus (not depicted).

For each sample, 10 pieces were measured, and their average value was determined. As a result, the load at which the layers peeled off from each other was 30 MPa in the sample with the inner electrode coverage ratio of 80%. On the other hand, the load was 17 MPa in the sample with the inner electrode coverage ratio of 95%. Namely, the case with the inner electrode coverage ratio of 80% yielded an interlayer strength which was nearly twice as high as that in the case with the inner electrode coverage ratio of 95%.

Since the inner electrode layers 4 are formed with a plurality of holes 6 as in the foregoing, the load weight exerted on the piezoelectric layers 3 from the inner electrode layers 4 is reduced, whereby the piezoelectric layers 3 are easier to deform. As a consequence, the amount of displacement of piezoelectric layers 3 can be enhanced even when the piezoelectric layers 3 are thinned. Also, the bonding strength between the piezoelectric layers 3 and inner electrode layers 4 becomes higher, whereby the durability of the multilayer piezoelectric element 1 can be improved.

Though the inner electrode layers 4 were formed from metals including Ag and Pd in the above-mentioned multilayer piezoelectric element 1, it will be sufficient for a metal material constituting the inner electrode layers 4 to contain one or a plurality of species of Ag, Pd, Pt, and Au. The metal material constituting the inner electrode layers 4 may be mainly composed of Cu (copper) which is a base metal. In particular, Cu is relatively easy to obtain and inexpensive. Therefore, when the inner electrode layers 4 are formed from a metal material mainly composed of Cu, the amount of displacement of the piezoelectric layers 3 can be enhanced while cutting down the cost of the multilayer piezoelectric element 1.

A procedure of making a multilayer piezoelectric element 1 including inner electrode layers 4 containing Cu as a main ingredient will be explained in brief. When forming green sheets, a piezoelectric ceramic powder mainly composed of PZT (lead zirconate titanate) having the following composition, for example, is used as a ceramic material for constructing piezoelectric layers 3. The procedure of forming the green sheets is the same as that in the making of the multilayer piezoelectric element 1 mentioned above.

(Pb0.955 Sr0.04) [(Zn⅓ Nb⅔) 0.1 Zr0.47 Ti0.43]O₃+0.1 wt % of Sb₂O₃ per 1 mol of the main ingredient +0.1 wt % of NiO per 1 mol of the main ingredient +0.002 wt % of MnO per 1 mol of the main ingredient

When printing inner electrode patterns onto the green sheets made of the above-mentioned ceramic material, a Cu powder is used as a metal material for the inner electrode patterns. The procedure of the step of printing the inner electrode patterns is the same as that in the making of the multilayer piezoelectric element 1 mentioned above.

A plurality of green sheets printed with inner electrode patterns are laminated and pressed, so as to complete a multilayer body, which is then degreased. In the degreasing step, the multilayer body is mounted on a setter, the oxygen partial pressure is adjusted to about 4×10⁻¹⁵ atm with a nitrogen gas and a hydrogen gas, and the processing is performed for about 25 hours at about 600° C. in this atmosphere. Thereafter, the multilayer body is fired. In the firing step, the setter mounted with the multilayer body is put into a closed furnace, the oxygen partial pressure is adjusted to about 2×10⁻⁸ atm with the nitrogen gas and hydrogen gas, and the firing is performed for about 3 hours at about 950° C.

In the steps of degreasing and firing the multilayer body, the nitrogen gas and hydrogen gas are used for adjusting the oxygen partial pressure in order to keep Cu, which is a main ingredient of the material forming the inner electrode layers 4, from being oxidized. The other steps are the same as those in the making of the multilayer piezoelectric element 1 mentioned above.

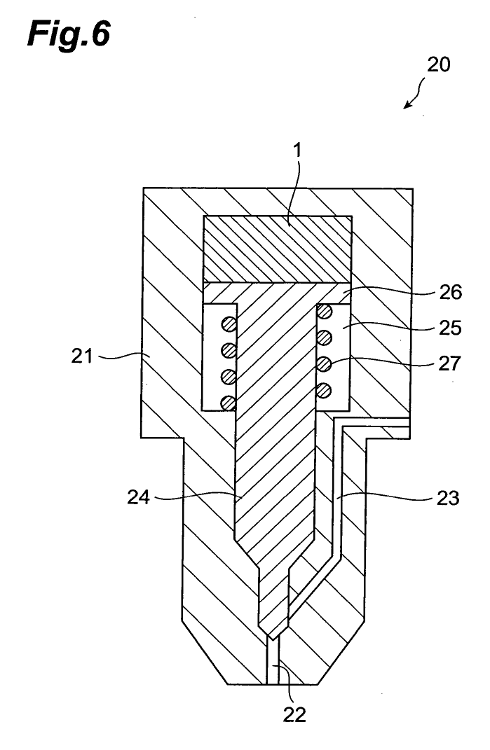

FIG. 6 is a schematic view showing a fuel injector equipped with the above-mentioned multilayer piezoelectric element 1. The fuel injector 20 in accordance with this embodiment in the drawing is one used in an internal combustion engine such as a car engine.

The fuel injector 20 includes a body 21, whereas a leading end portion of the body 21 is provided with an injection port 22 for injecting a fuel. Provided within the body 21 are a fuel passage 23 communicating with the injection port 22 and a needle valve 24 for opening and closing the injection port 22. The fuel passage 23 is connected to an external fuel source (not depicted). The needle valve 24 includes a piston 26 slidable within a space 25 formed in the body 21. Also provided within the space 25 is the above-mentioned multilayer piezoelectric element 1 firmly attached to the piston 26.

In the state where the injection port 22 is opened by the needle valve 24 in such a fuel injector 20, the fuel supplied to the fuel passage 23 is injected into a combustion chamber (not depicted) of the internal combustion engine from the injection port 22. When the multilayer piezoelectric element 1 expands in response to a voltage applied thereto, the piston 26 of the needle valve 24 is pressed against a spring 27, so as to close the injection port 22, thereby terminating the injection of the fuel.

As mentioned above, the multilayer piezoelectric element 1 has a large amount of displacement. Therefore, the amount of injection of fuel can be made greater and smaller as the amount of expansion of the multilayer piezoelectric element 1 is adjusted. Namely, the amount of injection of fuel can be regulated over a wide range.

The bonding strength between the piezoelectric layers 3 and inner electrode layers 4 is high in the multilayer piezoelectric element 1 as mentioned above. Therefore, when the needle valve 24 moves as the multilayer piezoelectric element 1 expands/contracts, the multilayer piezoelectric element 1 is kept from losing against the tensile strength of the needle valve 24 and letting the piezoelectric layers 3 and inner electrode layers 4 peel from each other. Therefore, the durability of the fuel injector 20 is improved.

The present invention is not limited to the above-mentioned embodiment. For example, though the holes 6 are formed like a porous portion in the inner electrode layers 4 in the multilayer piezoelectric element 1 in accordance with the above-mentioned embodiment, the number of holes 6 formed in the inner electrode layers 4 may be 1. Though the holes 6 are formed in all the inner electrode layers 4, it will be sufficient if the holes 6 are formed in at least one inner electrode layer 4.

In the multilayer piezoelectric element 1 in accordance with the above-mentioned embodiment, a plurality of electrode layers 4A are electrically connected to each other with the outer electrode 5A, while a plurality of electrode layers 4B are electrically connected to each other with the outer electrode 5B. Instead of the outer electrodes 5A, 5B, a through hole electrode for electrically connecting the electrode layers 4A to each other and a through hole electrode for electrically connecting the electrode layers 4B to each other may be provided within the piezoelectric layers 3.

The multilayer piezoelectric element in accordance with the present invention is also employable in apparatus other than the fuel injector, such as a micropump, for example.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A multilayer piezoelectric element constructed by alternately laminating a piezoelectric layer and an inner electrode layer;
wherein the piezoelectric element includes a plurality of inner electrode layers;
wherein the plurality of inner electrode layers include a first electrode layer and a second electrode layer having a region opposing the first electrode layer by way of the piezoelectric layer;
wherein a region where the first and second electrode layers overlap forms a piezoelectrically active region adapted to displace the piezoelectric layer when a voltage is applied between the first and second electrode layers;
wherein at least one of the plurality of inner electrode layers is formed with a perforated portion penetrating therethrough in a laminating direction; and
wherein the perforated portion is formed in at least a region corresponding to the piezoelectrically active region in the inner electrode layer.

2. A multilayer piezoelectric element according to claim 1, wherein the perforated portion is formed as a porous portion in at least the region corresponding to the piezoelectrically active region in the inner electrode layer.

3. A multilayer piezoelectric element according to claim 1, wherein the inner electrode layers are formed from a material mainly composed of copper.

4. A fuel injector comprising a body formed with an injection port for injecting a fuel;
a valve, disposed within the body, for opening and closing the injection port; and
a multilayer piezoelectric element for driving the valve;
wherein the multilayer piezoelectric element is constructed by alternately laminating a piezoelectric layer and an inner electrode layer;
wherein the piezoelectric element includes a plurality of inner electrode layers, the plurality of inner electrode layers including a first electrode layer and a second electrode layer having a region opposing the first electrode layer by way of the piezoelectric layer;
wherein a region where the first and second electrode layers overlap forms a piezoelectrically active region adapted to displace the piezoelectric layer when a voltage is applied between the first and second electrode layers;
wherein at least one of the plurality of inner electrode layers is formed with a perforated portion penetrating therethrough in a laminating direction; and
wherein the perforated portion is formed in at least a region corresponding to the piezoelectrically active region in the inner electrode layer.

5. A multilayer piezoelectric element comprising:
a piezoelectric layer; and
first and second electrode layers positioned such that at least partial regions thereof oppose each other by way of the piezoelectric layer;
wherein at least the first electrode layer is formed with a perforated portion penetrating through the first electrode layer in a region opposing the second electrode layer.
